(19) United States
(12) Patent Application Publication
(10) Pub. No.: US 2005/0150915 A1
(43) Pub. Date: Jul. 14, 2005

(54) Food dispenser plunger system

(76) Inventor: Ronald Baretela, East Meadow, NY (US)

Correspondence Address: Michael S. Neustel, Suite No. 4, 2534 South University Drive, Fargo, ND, 58103, US

(21) Appl. No.: 10/754,266

(22) Filed: Jan. 9, 2004

(51) Int. Cl. B67D 5/06

(52) U.S. Cl. 222/509

(57) ABSTRACT

A food dispenser plunger system for providing efficient removal of the plunger for cleaning or repairs. The food dispenser plunger system includes an upper plunger removably connected to a lower plunger. The upper plunger includes a threaded shaft that threadably mates with a threaded aperture within the lower plunger. The upper plunger and the lower plunger are removed from the upper portion of the dispensing head.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to food dispenser machines and more specifically it relates to a food dispenser plunger system for providing efficient removal of the plunger for cleaning or repairs.

2. Description of the Related Art

Food dispenser plungers have been in use for years for dispensing soft serve ice cream, soft serve yogurt, soft serve ice slush and other foods. Food dispenser plungers are comprised of a single plunger structure that is movably positioned within a dispensing head of a food dispenser machine. FIG. 1 illustrates an exemplary prior art food dispenser plunger having a single plunger structure.

The main problem with conventional plungers for food dispenser machines is that they cannot be easily removed for cleaning, repair and maintenance from the dispensing head because of an overhang extending above the dispensing head. In order to remove the plunger, the food dispenser machine must be disassembled which is time consuming thereby increasing the downtime of the food dispenser. In addition, disassembly of the food dispenser machine can be messy and can result in lost parts for the food dispenser machine.

While these devices may be suitable for the particular purpose to which they address, they are not as suitable for providing efficient removal of the plunger for cleaning or repairs. Conventional single structure plungers for food dispenser machines are difficult to remove for cleaning, repairing and maintenance.

In these respects, the food dispenser plunger system according to the present invention substantially departs from the conventional concepts and designs of the prior art, and in so doing provides an apparatus primarily developed for the purpose of providing efficient removal of the plunger for cleaning or repairs.

### BRIEF SUMMARY OF THE INVENTION

In view of the foregoing disadvantages inherent in the known types of food dispenser plungers now present in the prior art, the present invention provides a new food dispenser plunger system construction wherein the same can be utilized for providing efficient removal of the plunger for cleaning or repairs.

The general purpose of the present invention, which will be described subsequently in greater detail, is to provide a new food dispenser plunger system that has many of the advantages of the food dispenser plungers mentioned heretofore and many novel features that result in a new food dispenser plunger system which is not anticipated, rendered obvious, suggested, or even implied by any of the prior art food dispenser plungers, either alone or in any combination thereof.

To attain this, the present invention generally comprises an upper plunger removably connected to a lower plunger. The upper plunger includes a threaded shaft that threadably mates with a threaded aperture within the lower plunger. The upper plunger and the lower plunger are removed from the upper portion of the dispensing head.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a food dispenser plunger system that will overcome the shortcomings of the prior art devices.

A second object is to provide a food dispenser plunger system for providing efficient removal of the plunger for cleaning or repairs.

Another object is to provide a food dispenser plunger system that reduces the amount of time required to remove and replace a plunger within a food dispenser machine.

An additional object is to provide a food dispenser plunger system that can be utilized within various types of food dispenser machines.

A further object is to provide a food dispenser plunger system that eliminates the requirement of disassembling the food dispenser machine.

Another object is to provide a food dispenser plunger system that reduces food dispenser machine downtime.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of a prior art single structure plunger.

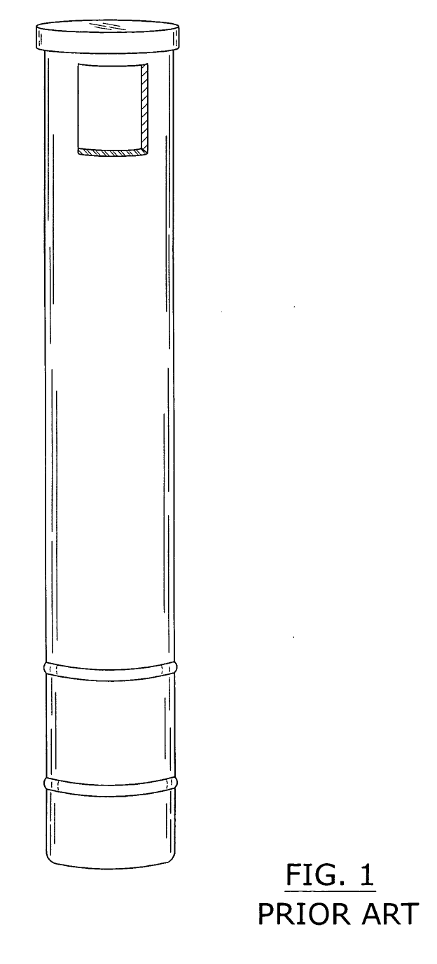

FIG. 2 is an upper perspective view of the present invention.

FIG. 3 is an exploded upper perspective view of the present invention.

FIG. 4 is a cross sectional view taken along line 4-4 of FIG. 2.

FIG. 5 is a cross sectional view taken along line 5-5 of FIG. 3.

FIG. 6 is a partial cutaway perspective view of the present invention positioned within a dispensing head.

FIG. 7 is a side cutaway view of the present invention positioned within a dispensing head.

FIG. 8 is a side cutaway view of the present invention being removed from a dispensing head.

### DETAILED DESCRIPTION OF THE INVENTION

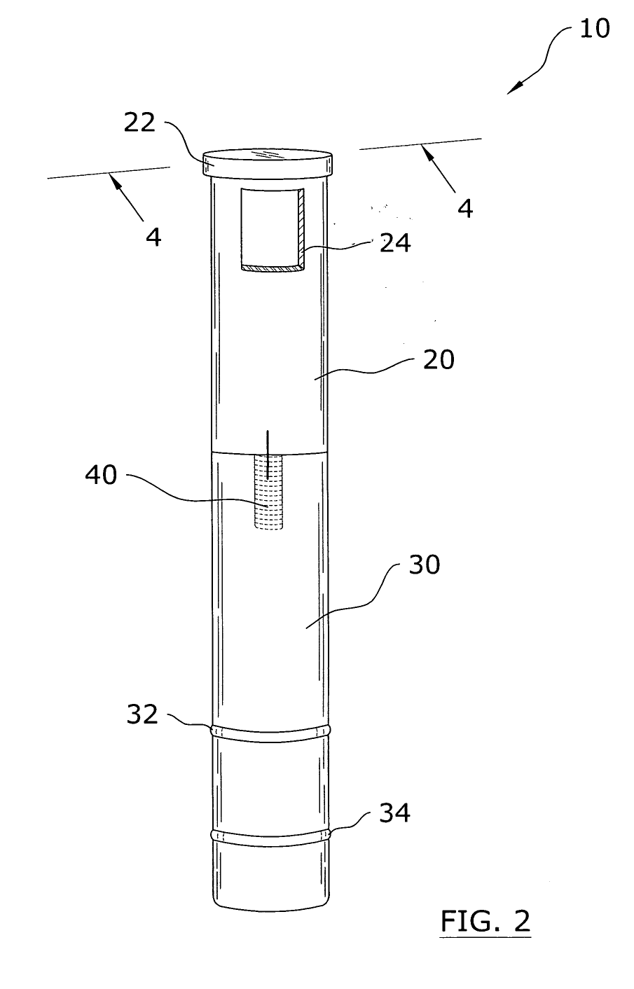

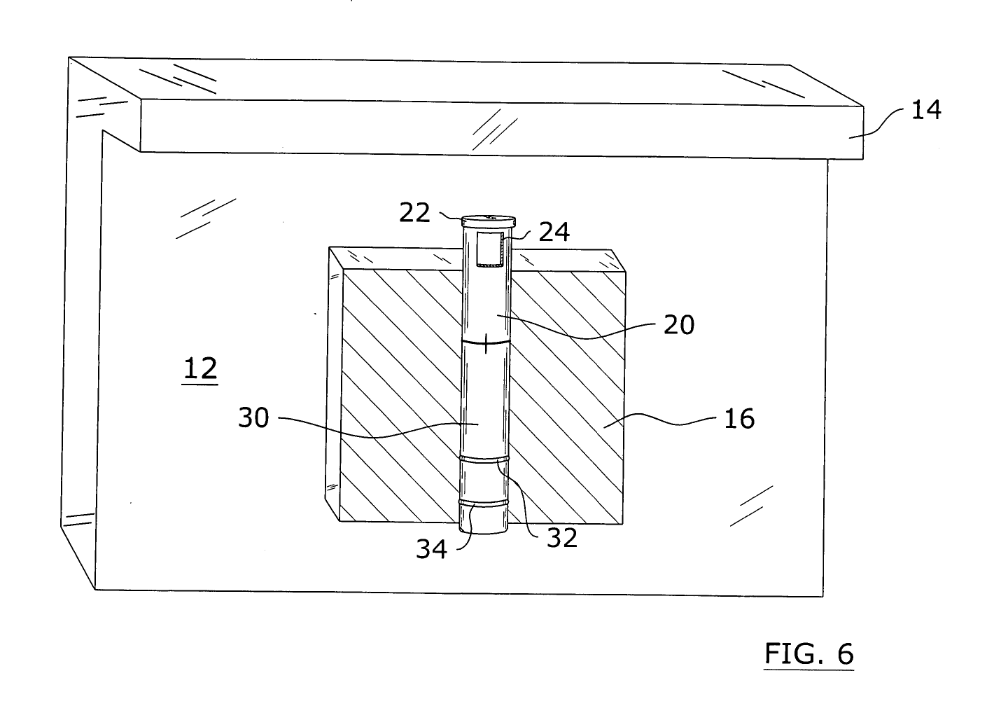

Turning now descriptively to the drawings, in which similar reference characters denote similar elements throughout the several views, FIGS. 2 through 7 illustrate a food dispenser plunger system 10, which comprises an upper plunger 20 removably connected to a lower plunger 30. The upper plunger 20 includes a threaded shaft 40 that threadably mates with a threaded aperture 50 within the lower plunger 30. The upper plunger 20 and the lower plunger 30 are removed from the upper portion of the dispensing head 16.

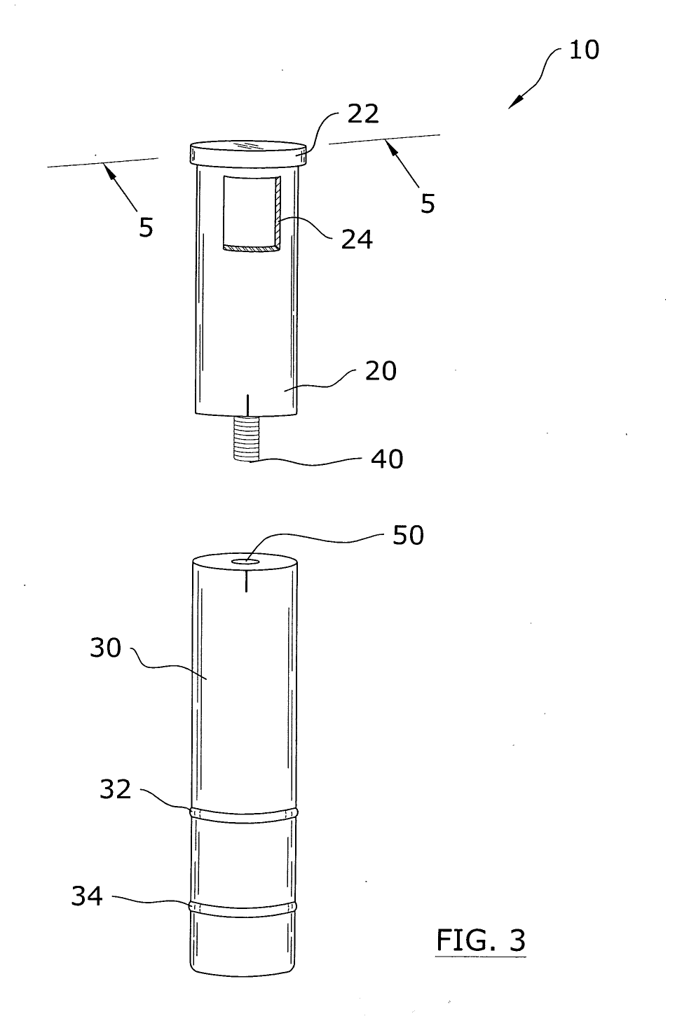

FIGS. 2 and 3 best illustrate the upper plunger 20 and the lower plunger 30. An orientation groove may be placed within the upper plunger 20 and the lower plunger 30 for properly aligning the plungers 20, 30 as shown in FIG. 3.

When the upper plunger 20 and the lower plunger 30 are interconnected, their combined structure is similar to a conventional solid structure plunger. The upper plunger 20 and the lower plunger 30 have a substantially similar cross sectional shape and size as shown in FIGS. 2 through 5 of the drawings. The lower plunger 30 may have a first seal 32 and a second seal 34 as shown in FIGS. 2 and 3 of the drawings.

As shown in FIGS. 2 through 5 of the drawings, the upper plunger 20 preferably includes an upper flange 22 and a receiver opening 24. The receiver opening 24 is well known in the art for receiving a portion of the handle for lifting and lowering the plunger structure within the dispensing head 16 of a food dispenser machine 12. The flange is also well known in the art for preventing the plunger structure from extending too far into the dispensing head 16 of the food dispenser machine 12. It can be appreciated that the upper plunger 20 may have various other shapes and structures to accommodate various dispensing heads 16.

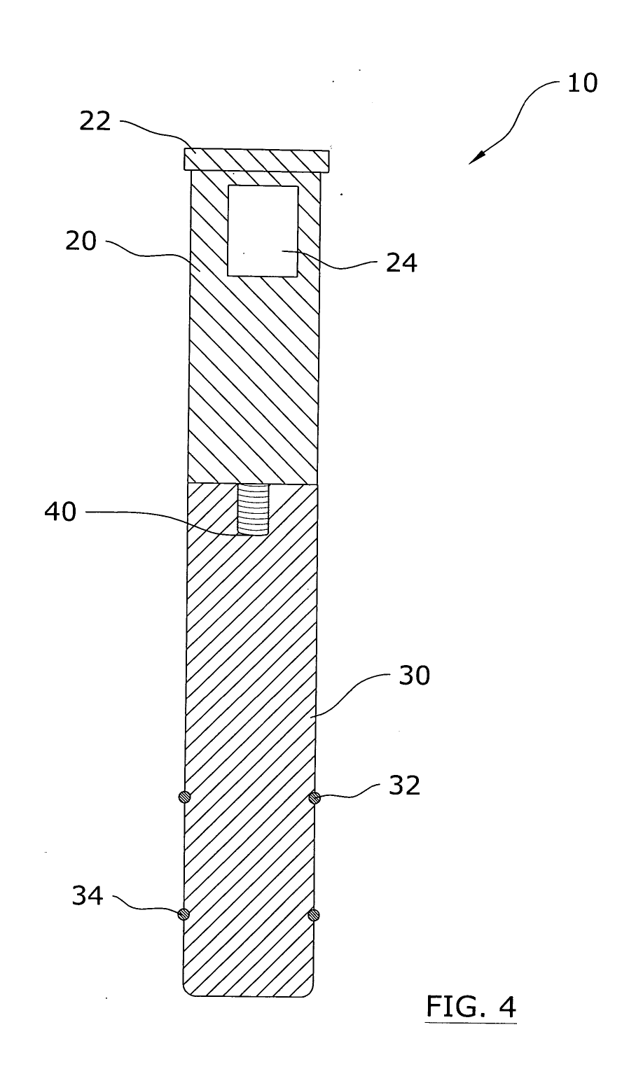

The lower plunger 30 is removably connectable to the upper plunger 20 as shown in FIGS. 2 though 5 of the drawings. The upper plunger 20 and the lower plunger 30 preferably form a relatively solid plunger structure having a longitudinal axis when connected together as shown in FIGS. 2 and 4 of the drawings.

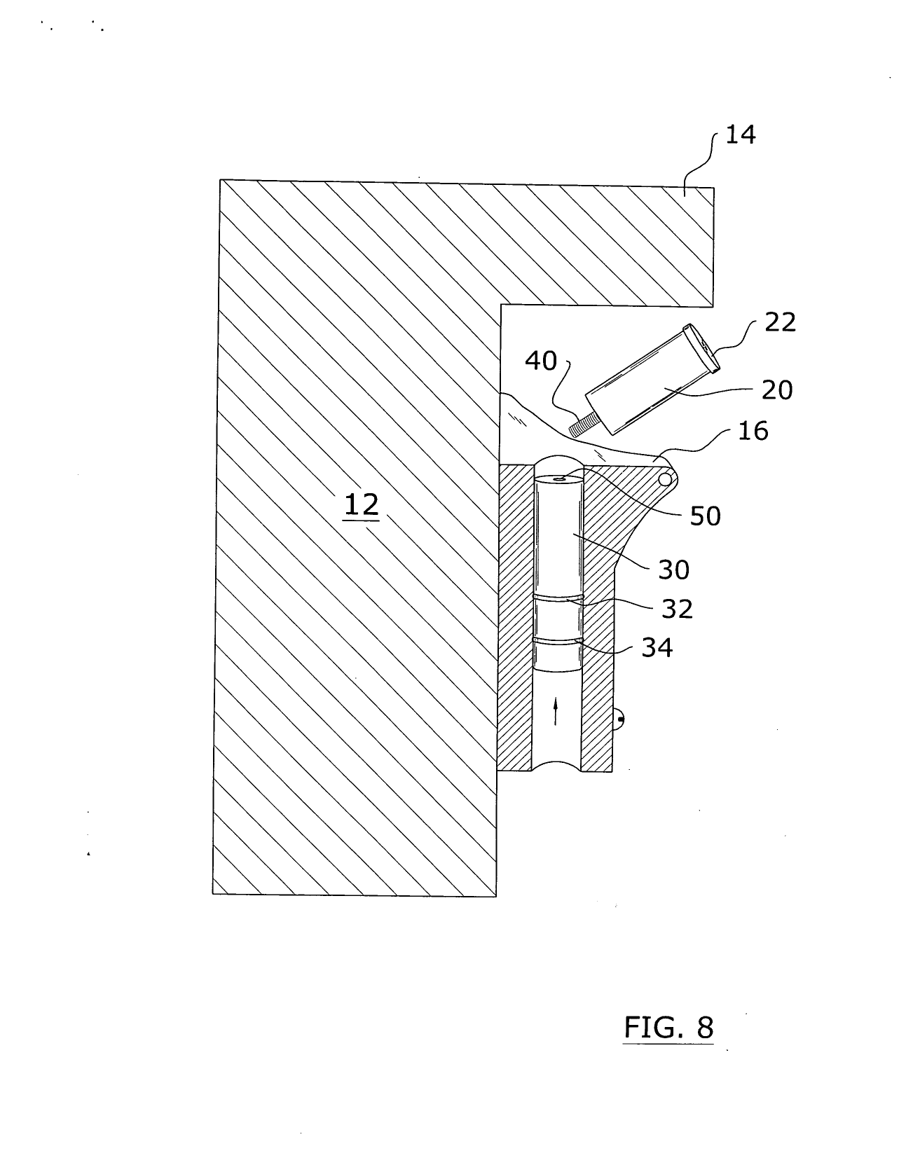

As shown in FIGS. 2 through 5 of the drawings, the upper plunger 20 is preferably shorter in length than the lower plunger 30. The upper plunger 20 is comprised of less than 50% of a total length when the upper plunger 20 and the lower plunger 30 connected together. The upper plunger 20 is preferably approximately 2½ inches in length and the lower plunger 30 is approximately 3½ inches in length. The shorter length of the upper plunger 20 allows for easy removal through the upper opening of the dispensing head 16 even with an overhang 14 as shown in FIG. 8 of the drawings. The lower plunger 30 may simply be removed through the upper opening of the dispensing head 16 as shown in FIG. 8 of the drawings.

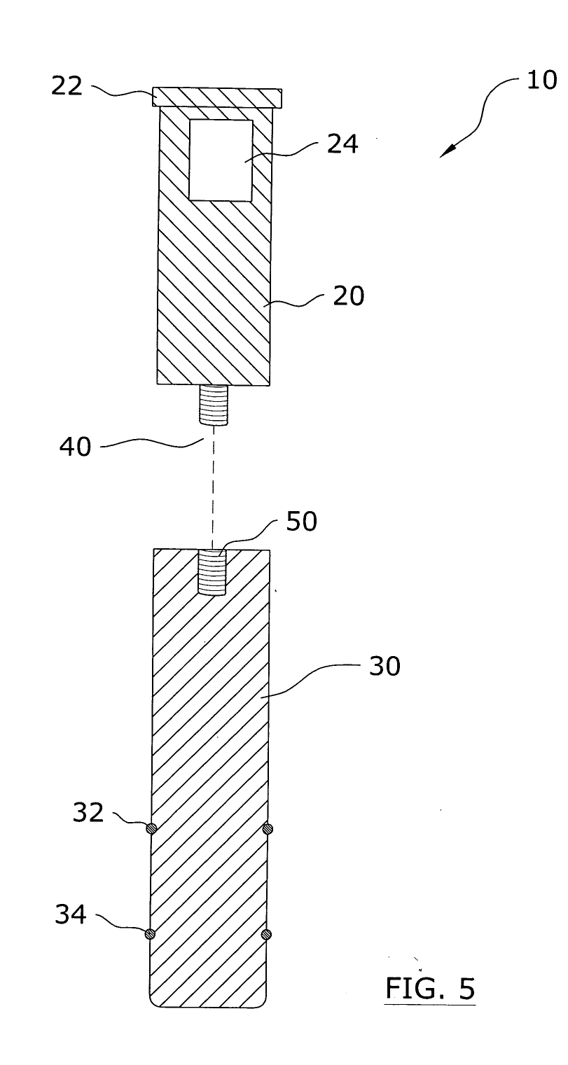

The upper plunger 20 preferably includes a threaded shaft 40 extending from a lower end of the upper plunger 20 as shown in FIGS. 3 and 5 of the drawings. The lower plunger 30 preferably includes a threaded aperture 50 extending into an upper end of the lower plunger 30 for threadably receiving the threaded shaft 40 as shown in FIGS. 3 and 5 of the drawings.

In an alternative embodiment, the lower plunger 30 may include a threaded shaft 40 extending from an upper end of the lower plunger 30. The upper plunger 20 includes a threaded aperture 50 extending into a lower end of the upper plunger 20 for threadably receiving the threaded shaft 40 in the alternative embodiment.

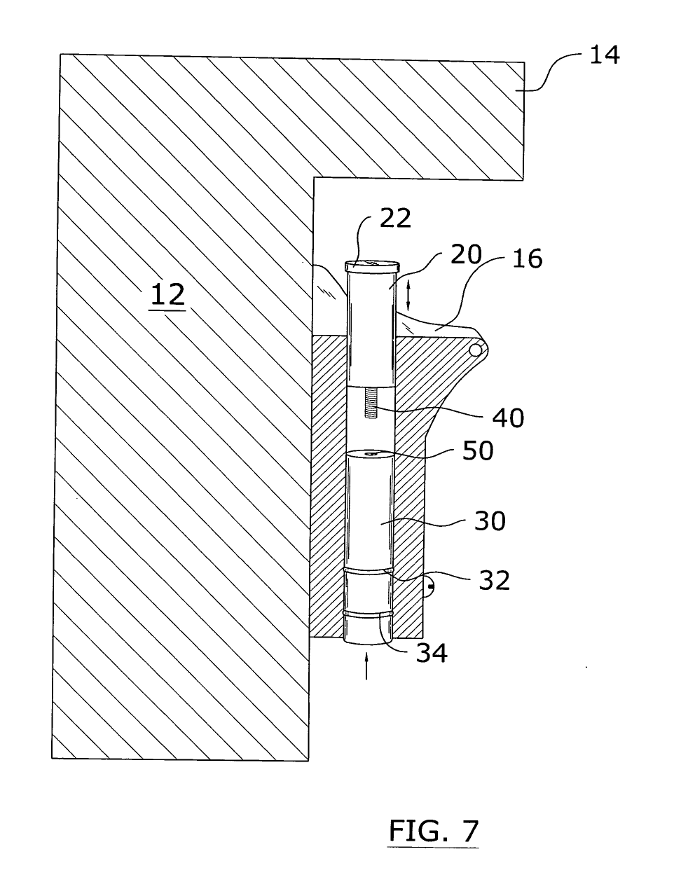

To assemble the plunger structure within a dispensing head 16, the upper plunger 20 is inserted into an upper opening within a dispensing head 16 of a food dispenser machine 12 as shown FIG. 7 of the drawings. Because of the relatively short length of the upper plunger 20, the upper plunger 20 may be inserted into the upper opening of the dispensing head 16 without disassembly of the food dispenser machine 12 even with an overhang 14. The lower plunger 30 is then inserted into a lower opening within the dispensing head 16 of the food dispenser machine 12 as shown in FIG. 7 of the drawings. It can be appreciated that the order of insertion of the plungers 20, 30 may be reversed. The lower plunger 30 and the upper plunger 20 are then rotated with respect to one another thereby causing the threaded shaft 40 to threadably engage the threaded aperture 50. The user continues to thread the threaded shaft 40 into the threaded aperture 50 until the lower end of the upper plunger 20 and the upper end of the lower plunger 30 are adjacent to one another. The present invention may thereafter be utilized as a conventional plunger would be utilized for controlling the flow of liquid food from the dispensing head 16.

To remove the plunger structure from the dispensing head 16, the user rotates the upper plunger 20 and the lower plunger 30 with respect to one another to unthread the threaded shaft 40 from the threaded aperture 50. After the threaded shaft 40 is removed from the threaded aperture 50, the user then removes the lower plunger 30 through the lower opening of the dispensing head 16 as shown in FIG. 8 of the drawings. The user then removes the upper plunger 20 through the upper opening of the dispensing head 16 as further shown in FIG. 8 of the drawings. It can be appreciated that the order of removal of the plungers 20, 30 may be reversed.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A food dispenser plunger for a food dispenser machine, comprising:
an upper plunger; and
a lower plunger removably connectable to said upper plunger.

2. The food dispenser plunger of claim 1, wherein said upper plunger and said lower plunger form a relatively solid plunger structure having a longitudinal axis when connected together.

3. The food dispenser plunger of claim 1, wherein said upper plunger is shorter in length than said lower plunger.

4. The food dispenser plunger of claim 1, wherein said upper plunger is comprised of less than 50% of a total length when said upper plunger and said lower plunger connected together.

5. The food dispenser plunger of claim 1, wherein said upper plunger includes a threaded shaft extending from a lower end of said upper plunger, and wherein said lower plunger includes a threaded aperture extending into an upper end of said lower plunger for threadably receiving said threaded shaft.

6. The food dispenser plunger of claim 1, wherein said lower plunger includes a threaded shaft extending from an upper end of said lower plunger, and wherein said upper plunger includes a threaded aperture extending into a lower end of said upper plunger for threadably receiving said threaded shaft.

7. The food dispenser plunger of claim 1, wherein said upper plunger and said lower plunger have a substantially similar cross sectional shape and size.

8. The food dispenser plunger of claim 1, wherein said upper plunger and said lower plunger form a relatively solid plunger structure having a longitudinal axis when connected together, wherein said upper plunger is comprised of less than 30% of a total length when said upper plunger and said lower plunger connected together, wherein said upper plunger includes a threaded shaft extending from a lower end of said upper plunger, and wherein said lower plunger includes a threaded aperture extending into an upper end of said lower plunger for threadably receiving said threaded shaft.

9. The food dispenser plunger of claim 8, wherein said upper plunger and said lower plunger have a substantially similar cross sectional shape and size.

10. A method of assembling and disassembling a plunger within a dispensing head of a food dispenser machine, wherein said plunger is comprised of an upper plunger and a lower plunger removably connectable to said upper plunger, said method comprising the steps of:
inserting said upper plunger into an upper opening within a dispensing head of a food dispenser machine;
inserting said lower plunger into a lower opening within said dispensing head of said food dispenser machine; and
threading a threaded shaft of said upper plunger into engagement within a threaded aperture of said lower plunger.

11. The method of assembling and disassembling a plunger within a dispensing head of a food dispenser machine of claim 10, including the steps of:
rotating said upper plunger and said lower plunger with respect to one another for unthreading said threaded shaft from said threaded aperture;
removing said upper plunger through said upper opening; and
removing said lower plunger through said upper opening.
